(19) United States
(12) Patent Application Publication
(10) Pub. No.: US 2009/0292934 A1
(43) Pub. Date: Nov. 26, 2009

(54) INTEGRATED CIRCUIT WITH SECONDARY-MEMORY CONTROLLER FOR PROVIDING A SLEEP STATE FOR REDUCED POWER CONSUMPTION AND METHOD THEREFOR

(75) Inventor: James Lyall Esliger, Richmond Hill (CA)

Correspondence Address: ADVANCED MICRO DEVICES, INC.;C/O VEDDER PRICE P.C., 222 N.LASALLE STREET, CHICAGO, IL, 60601, US

(73) Assignee: ATI Technologies ULC, Markham (CA)

(21) Appl. No.: 12/125,549

(22) Filed: May 22, 2008

(51) Int. Cl. G06F 1/00; G06F 12/00

(52) U.S. Cl. 713/323; 711/101; 711/105; 711/E12.001

(57) ABSTRACT

A method comprising determining that a minimum operation level of an integrated circuit (100) has been reached and that a sleep mode is therefore allowable; storing minimum operation context information to a RAM (115) in response to determining that the minimum operation level has been reached; switching to a sleep mode code (116) in the RAM (115); and transferring memory control from a primary memory controller (104) to a secondary memory controller (112) wherein only the secondary memory controller (112) controls the RAM (115). The method may include storing the sleep mode code (116) and a wakeup code (117) in the RAM (115) in response to determining that sleep mode is allowable, where the wakeup code (117) restores a minimum operation context using the minimum operation context information stored in the RAM (115). The method may also include placing a plurality of integrated circuit power islands into a sleep mode and leaving a secondary memory controller power island (109) in a normal power mode.

### FIELD OF THE DISCLOSURE

The present disclosure is related to integrated circuits and power management in integrated circuits.

### BACKGROUND

Battery powered electronic devices incorporating integrated circuits such as System-On-Chip (SOC) integrated circuits incorporate various power modes for saving power during times when the electronic device is idle. For example, electronic devices such as mobile telecommunication devices are normally kept powered on at all times in order to receive incoming phone calls and thus may go for many minutes or hours without usage. An operating software or other similar software on the device may monitor activity of the device and/or employ timers such that various idle states result in the device switching into reduced power modes.

Integrated circuit technology has developed various techniques for reducing power consumption by the integrated circuit, therefore saving power consumption for an electronic device overall. On such technique employs an architecture having “power islands” where some functions may be isolated from others. For example, a CPU may be located on its own power island so that other surrounding power islands may be placed in sleep modes, or shutdown, without effecting the CPU.

As would be understood, at least one power island must be “always-on,” that is, powered-on so that when the integrated circuit switches to a waking state, normally based on some detected event, a context may be provided to restore the operating system, and/or other software and logic, to their respective operating states prior to entering the sleep mode and, at least temporarily, halting operations. In order to accomplish this task, context information must be stored during the sleep state and must be retrievable at the wake-up event. The storage and access control of such information, and also its restoration requires power, which is a limitation on how “deep” of a sleep (“deep sleep”) an integrated circuit may enter without having to entertain a complete reboot, thereby losing any operational context prior to the sleep state.

Therefore, it would be desirable to have a way to maintain context information and place as many power islands into sleep mode as possible.

### BRIEF DESCRIPTION OF THE DRAWINGS

FIG. 1 is a block diagram of an integrated circuit having a plurality of circuit islands, a primary memory controller located on a primary memory controller island, and a secondary memory controller located on a secondary island in accordance with an embodiment.

FIG. 2 is a state diagram illustrating various power states for sleep modes of an integrated circuit and for the plurality of circuit islands as shown in FIG. 1, in accordance with the embodiments.

FIG. 3 is a flow chart illustrating high level operation of an integrated circuit entering sleep mode in accordance with the embodiments.

FIG. 4 is a flow chart illustrating high level operation of an integrated circuit waking from sleep mode in accordance with the embodiments.

FIG. 5 is a flow chart illustrating additional details of one embodiment where an integrated circuit is entering sleep mode.

FIG. 6 is a flow chart illustrating additional details of one embodiment where an integrated circuit is waking from sleep mode.

FIG. 7 is a signal flow diagram showing details of messages or other interactions between various logic and software for an integrated circuit entering sleep mode in accordance with an embodiment.

FIG. 8 is a signal flow diagram showing details of messages or other interactions between various logic and software for an integrated circuit waking from sleep mode in accordance with an embodiment.

### DETAILED DESCRIPTION

An embodiment herein disclosed provides a method comprising determining that a minimum operation level of an integrated circuit has been reached and that a sleep mode is therefore allowable; storing minimum operation context information to a random access memory (RAM) in response to determining that the minimum operation level has been reached; switching to a sleep mode code in the RAM; and transferring memory control from a primary memory controller to a secondary memory controller wherein the secondary memory controller only controls the RAM.

The method may include storing the sleep mode code and a wakeup code to the RAM in response to determining that the minimum operation level has been reached, where the wakeup code is operative to restore a minimum operation context using the minimum operation context information stored in the RAM. The method may also include placing a plurality of integrated circuit power islands into a powered off mode and leaving a secondary memory controller power island in a normal power mode. The secondary memory controller power island may also be placed in a low power mode wherein the applied power is lowered and clocks are turned off or reduced. A wakeup event may restore the clocks.

In another embodiment herein disclosed, a method includes receiving a hardware interrupt in an integrated circuit, when the integrated circuit is in a sleep mode; receiving a request to wakeup the integrated circuit in response to receiving the hardware interrupt; accessing, by the secondary memory controller, a wakeup code, the wakeup code stored in a RAM and for restoring a minimum operation context of the integrated circuit; executing the wakeup code and restoring a minimum operation context of the integrated circuit; and transferring memory control from the secondary memory controller to a primary memory controller.

The method may also include, prior to transferring memory control from the secondary memory controller to a primary memory controller, restoring power to a primary memory controller power island of the integrated circuit; and restoring a full operation context of the integrated circuit using a full operation context information stored in the RAM.

The embodiments also include an integrated circuit with a random access memory (RAM); a primary memory controller operatively coupled to the RAM and to other memory of the integrated circuit, where the primary memory controller is located on a memory controller island of a plurality of circuit islands; a secondary memory controller operatively coupled to the RAM and located on a secondary memory controller island, the secondary memory controller dedicated to control of the RAM upon transfer of control from the primary memory controller, and operative to provide access to a minimum operation context information from the RAM during a wakeup operation; and logic operative to transfer control from the primary memory controller to the secondary memory controller for entering a sleep mode of the integrated circuit which includes placing the memory controller island into sleep mode.

The integrated circuit of the embodiments may also include a processor operatively coupled to the RAM, the primary memory controller and the secondary memory controller, and operative to determine that a minimum operation level of an integrated circuit has been reached and that a sleep mode is therefore allowable; store minimum operation context information to the RAM in response to determining that the minimum operation level has been reached; switch to a sleep mode code in the RAM; and hand memory control from the primary memory controller to the secondary memory controller.

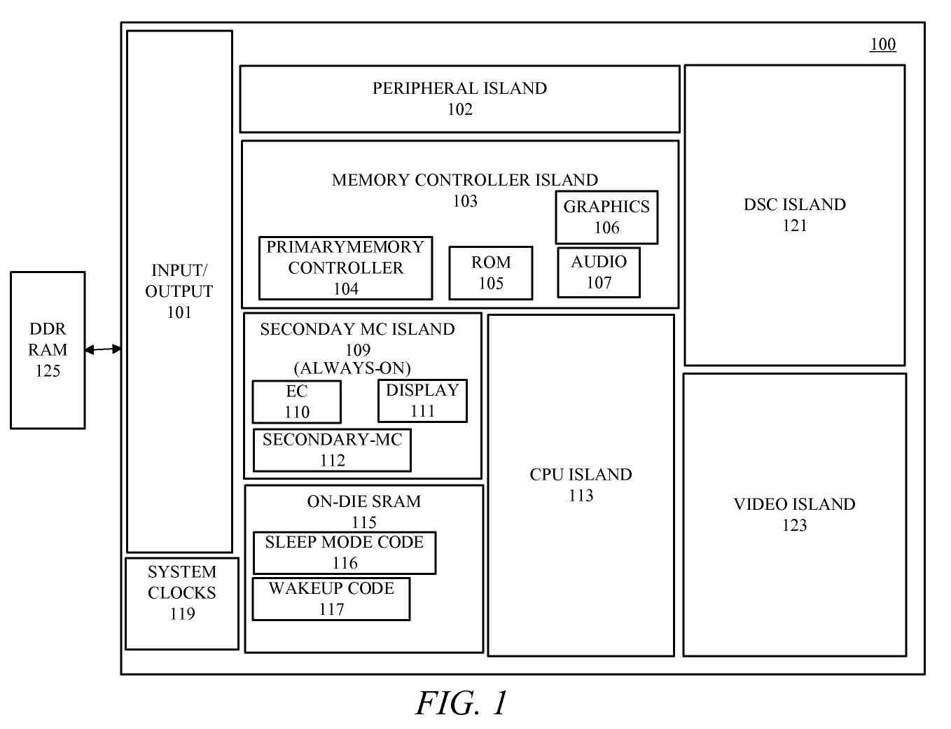

Turning now to the drawings wherein like numerals represent like components, FIG. 1 is a block diagram of an integrated circuit (IC) 100 which may be a System-on-Chip (SOC) integrated circuit in some embodiments. The IC 100 includes a central processing unit (CPU) which, for the exemplary embodiment illustrated by FIG. 1, is located on a CPU island 113. The integrated circuit 100 further includes a digital still camera (DSC) processor located on DSC island 121 and a video processor located on video island 123. Also present is a peripheral island 102 which may support various interfaces such as, but not limited to, USB, SD, UART, etc. An input/output module 101 provides various physical interfaces that may be associated with interfaces supported by the peripheral island 102. For example, the input/output module 101 may provide USB physical ports and other input/output ports and/or pads. Additionally, the input/output module 101 has an input port or pad for receiving an input voltage from a circuit board for example. The input/output module 101 may also be connected to an external double data rate synchronous random access memory, for example, DDR RAM 125. In accordance with the embodiment illustrated by FIG. 1, the integrated circuit 100 further includes a primary memory controller island 103. The primary memory controller island 103 further consists of a graphics processor 106, an audio processor 107, a read only memory RAM 105, and the primary memory controller 104. Also present is a secondary memory controller island 109. This island is an “always-on” island. That is, power is always supplied to the secondary memory controller island 109 even when the integrated circuit 100 enters into a sleep mode as will be explained in further detail herein.

The secondary memory controller island 109 includes the secondary memory controller 112, an energy controller 110, and a display controller 111. The secondary memory controller 112 is operatively coupled to an on-die random access memory (RAM) 115 and may control the on-die random access memory 115 for occasions when the integrated circuit 100 enters into a sleep mode. The on-die random access memory (RAM) 115 further includes a sleep mode code 116 and a wake up code 117 as will also be described further herein. The sleep mode code 116 and wakeup code 117 may only be present in RAM 115 when needed to enter sleep mode. Lastly, as shown in FIG. 1 the integrated circuit 100 also has system clocks 119 for providing clock signals to the various islands and also for providing lower rate clock signals to islands in certain instances of sleep mode.

It is to be understood that FIG. 1 and the other figures provided herein are exemplary only and are not necessarily for the purpose of illustrating a complete schematic diagram of an integrated circuit. For example, the integrated circuit shown in FIG. 1 may include other circuit islands or other components not shown in FIG. 1 that may be necessary for implementation of a complete SOC, for example. Therefore, FIG. 1, as well as the other figures provided herein are exemplary only and are for the purpose of explaining the various embodiments and logic required so that one of ordinary skill may make and use the embodiments as disclosed herein. Therefore, other circuit islands or logic may be present in an integrated circuit such as that illustrated by FIG. 1, and would remain in accordance with the various embodiments herein disclosed. Further, the various circuit islands illustrated may include, in addition to processors and/or other logic, power gating logic for controlling power input and/or power output to and from the various islands as well as other portions/components of the integrated circuit. Further, power gating logic may be present in various locations of the integrated circuit 100 for the purpose of controlling power inputs/outputs to the various islands.

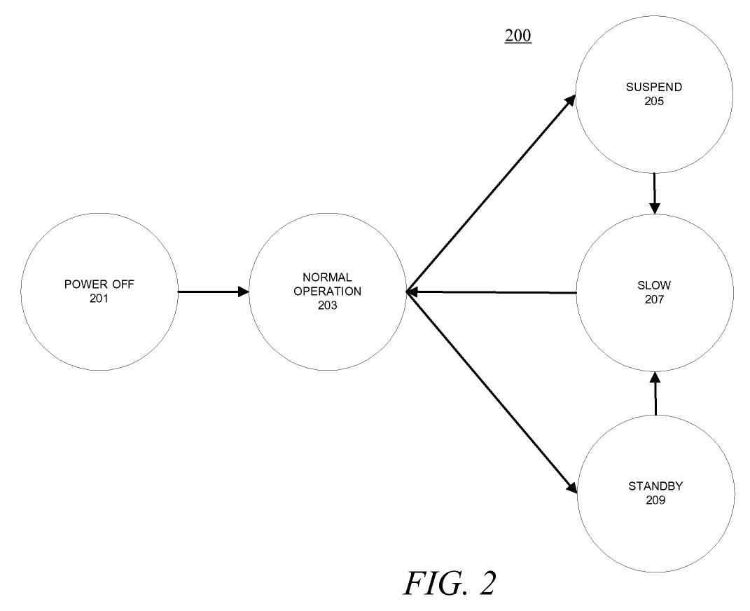

The various circuit islands illustrated in FIG. 1 such as, but not necessarily limited to, the memory controller island 103, the peripheral island 102, the DSC island 121, the CPU island 113 and the video island 123 may be internally power gated in some embodiments. Additionally, in some embodiments the on-die random access memory 115 may also have internal power gating. For example, the on-die RAM 115 may be gate-able in 32 KB increments. The on-die random access memory 115 may store the wake up code 117, such that the CPU located on CPU island 113 may utilize the wake up code 117 to speed up recovery from a sleep mode. The secondary memory controller island 109, which is always-on as was described previously, contains wake up sources and boot clock sources and may interact with system clocks 119 for the purpose of providing reduced power clocking signals to various circuit islands of the integrated circuit 100. Further, although the secondary memory controller island 109 is “always-on,” that is, always powered-on, it may not always be clocked. For example, the secondary memory controller island 109 may be powered on, but not clocked such that it is in a suspend state 205 as shown in FIG. 2.

The secondary memory controller 112 provides, among other advantages, a benefit in that it may be smaller and less complex than the primary memory controller 104. For example, by having access only to static RAM, such as on-die RAM 115, and not dynamic RAM such as DDR RAM 125, the secondary memory controller 112 need not include complex DDR interface logic. Further, a reduced number of clients are allowed access to the secondary memory controller 112, (i.e. no access by DSC, video, audio, etc.) resulting in even less complexity and size. Thus, the smaller size of the secondary memory controller 112, versus the size of the primary memory controller 104, provides an advantage in lower current leakage in a suspend mode, and lower power consumption in active mode, when compared to that of the primary memory controller 104.

An external memory such as the DDR RAM 125 may be controlled and placed in a self-refresh mode, when various circuit islands of integrated circuit 100 are in a sleep mode, in order to save additional power. Likewise, various logic of, for example, the input/output module 101, may also be powered off at various times in order to conserve power. For example, in some embodiments, a USB physical port and/or other ports, may be controlled to advantageously be turned off at opportune times, thereby conserving power.

FIG. 2 is a state diagram illustrating various power states that may be applied to the circuit islands of integrated circuit 100. For example, the integrated circuit 100 may be completely powered off as in 201. The integrated circuit 100 may enter a normal operation state as shown by normal operation state 203. In the various embodiments, normal operation may include a range of power states, for example, from a maximum power level to a low power level, or lower performance level, and may also include instances where some of the circuit islands of integrated circuit 100 are turned on or off. In a standby 209 state, the circuit islands may be turned off, however, some of the system clocks 119 may still be active. For example, one phase-locked loop (PLL) may remain running with its output gated, which, during wakeup, may be ungated. Since the PLL remains active, no additional wakeup time would be required due to the PLL needing to lock. In some embodiments a transitory state such as slow state 207 may be used to switch from the standby state 209 and suspend state 205 to the normal operating state 203. The suspend state 205 is also known as a “sleep mode.” In the suspend state 205 (or sleep mode), all circuit islands of integrated circuit 100 may be off, with the exception of the “always-on” secondary memory controller island 109 of the embodiments,“and the system clocks 119 may be gated by hardware. Therefore, the suspend state 205 represents a larger power savings for the integrated circuit 100, then the standby state 209.

In order for the integrated circuit 100 to determine when to enter a standby 209 or suspend state 205 from the normal operating state 203, the integrated circuit must have a triggering event. For example, an operating system executing on the CPU of CPU island 113 may monitor activity of the integrated circuit 100, and, if activity is low, take appropriate action to enter a suspend state 205 thereby saving power. Likewise, a wake up event of the integrated circuit 100 may trigger the CPU of CPU island 113 to enter the transitory slow state 207, and, ultimately, the normal operation state 203, thereby waking from the sleep mode or suspend state 205. Various events may trigger the integrated circuit 100 wake up such as an input occurring at the input/output module 101. Various other events would be understood by one of ordinary skill.

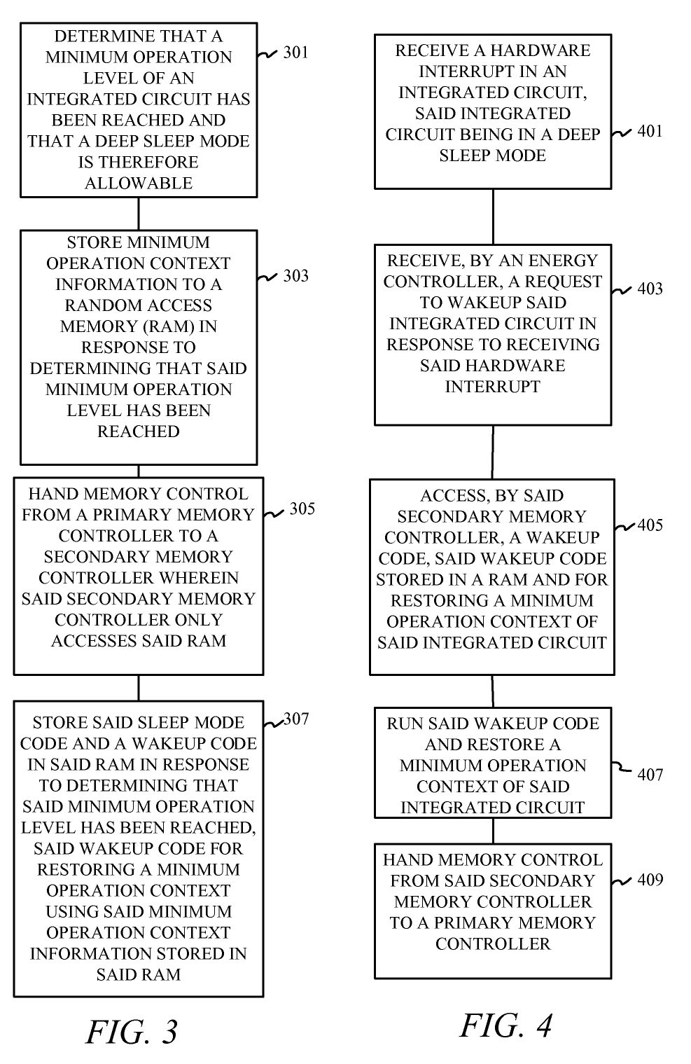

FIG. 3 illustrates a high level operation of the integrated circuit 100 for an embodiment wherein the integrated circuit 100 enters a sleep mode. Therefore, for example, in 301, the CPU, or more specifically an operating system (OS) executing on the CPU, may determine that a minimum operation level of the integrated circuit has been reached and that, therefore, a sleep mode is allowable. In accordance with the embodiments and as shown in 303, the operating system may store a minimum operation context information to a random access memory, such as on-die RAM 115, in response to determining that the minimum operation level has been reached. In 305, control of memory may be transferred from the primary memory controller 104 to the secondary memory controller 112 based on a command from the central processing unit on CPU island 113. The secondary memory controller 112 may only control the on-die RAM 115 in the various embodiments. That is, unlike the primary memory controller 104 which may provide access to various other memories of the integrated circuit 100, such as, but not limited to, ROM 105, the secondary memory controller 112 may only access the internal memory, that is, on-die RAM 115. In some embodiments, the transfer from the primary memory controller 104 to the second memory controller 112 may be accomplished by an energy controller 110. For example, the energy controller 110 may receive a command from the CPU causing the energy controller 110 to transfer from the primary memory controller 104 to the second memory controller 112.

As shown in 307, the OS executing on the CPU of CPU island 113, may store a sleep mode code and a wake up code in response to determining that the minimum operation level has been reached. The sleep mode code and wake up code will be stored on the on-die RAM 115, as shown in FIG. 1 as sleep mode code 116 and wakeup code 117. That is, the sleep mode code 116 and wakeup code 117 may only be present in RAM 115 when needed, such that the RAM 115 is available for other purposes during normal operation. The purpose of the wakeup code 117 is for restoring a minimum operation context using a minimum operation context information that was also stored in the on-die RAM 115 by the operating system and re-enabling the DDR RAM 125 which may store a complete operation context information.

FIG. 4 illustrates a high level wakeup operation of the integrated circuit 100 in accordance with the embodiments. In 401, the central processing unit on CPU island 113 may receive a hardware interrupt. The hardware interrupt may be received by the CPU while various islands of the integrated circuit 100 are in a sleep mode. As shown in 403, the CPU or operating system may request, via the energy controller, that the secondary memory controller island 109 access the wake up code 117 and the minimum operation context information also stored in the on-die SRAM 115, as shown in 405. The CPU may then execute the wakeup code 117 and restore the minimum operation context of the integrated circuit 100 as shown in 407. In 409, control of the memory may be transferred from the secondary memory controller 112 back to the primary memory controller 104 in preparation for restoring normal operation of the integrated circuit 100.

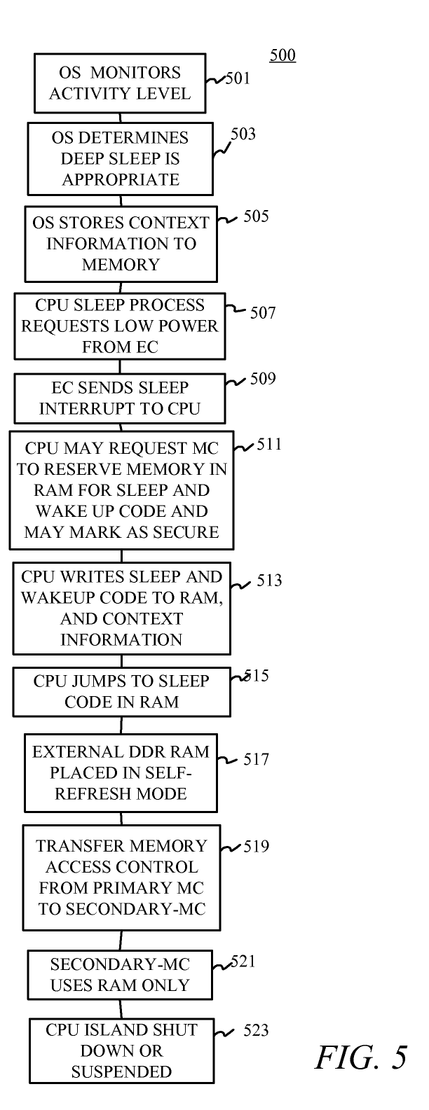

FIG. 5 shows additional details of the integrated circuit 100 for an embodiment wherein the integrated circuit enters a sleep mode. In 501, the operating system monitors an activity level of the integrated circuit 100. In 503, the operating system determines that a sleep mode is appropriate. For example, the integrated circuit 100 may have various circuit islands or may in general be inactive for a period of time as determined by timers. In 505, the operating system stores a context information to the memory, such as on-die RAM 115. In accordance with the sleep process, the CPU may then request a low power mode from the energy controller 110 located on the secondary memory controller island 109. In response, the energy controller 110 may send a sleep interrupt to the CPU as shown in 509. The CPU may then request the primary memory controller 104 to reserve memory in RAM 115 for the sleep mode code 116 and wake up code 117 as shown in 511. The memory controller, in 511 may also mark the reserved RAM 115 memory space as secure, if requested by the CPU 113. However, this memory reservation and/or marking memory as secure may not be present in all embodiments. As shown in 513, the CPU writes the sleep mode code 116 and wakeup code 117 and also context information to the on-die RAM 115. The CPU then jumps to the sleep mode code 116 as shown in 515. The sleep mode code 116 may then place the external memory in a self refresh mode as shown in 517. For example, the DDR RAM 125 may be placed in a self refresh mode. The DDR RAM 125 may be utilized for storing the overall context information, prior to entering the sleep mode, so that the OS may return to the operating condition that the OS was in prior to entering the sleep mode. Any suitable memory may be used for storing the context memory in accordance with the embodiments. By keeping the DDR RAM 125 in the self-refresh mode, power is conserved while the overall context information will be retrievable by the OS when needed upon wakeup operation. In the embodiments, the DDR RAM 125 stores, not only the overall context information, but the entire operating system (OS) image. After 517, the sleep mode code 116 may then transfer control of memory from the primary memory controller 104 to the secondary memory controller 112 via the energy controller 110, in some embodiments, as shown in 519. The secondary memory controller 112 then accesses only the on-die RAM 115 as shown in 521. In 523, the various islands including the CPU island 113 may be shut down or otherwise placed in a suspend state 205.

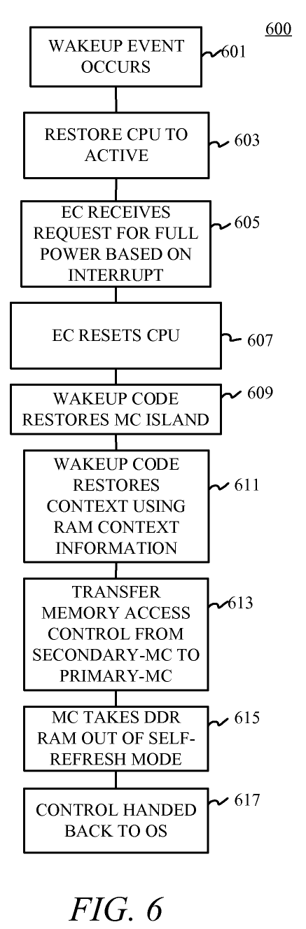

FIG. 6 illustrates a corresponding wakeup operation 600 corresponding to the integrated circuit 100 sleep mode operation 500 illustrated in FIG. 5. Thus, in 601, a wake up event occurs causing the integrated circuit 100 to restore the CPU to active as shown in 603. In 605, the energy controller 110 receives a request for normal power based on the system interrupt. In 607, the energy controller resets the CPU on CPU island 113. Next, the wake up code 117 may restore the primary memory controller island 103 as shown in 609. This may be done by the energy controller 110 in an alternative embodiment. In 611, the wake up code 117 may restore the context information using the context information stored in on-die RAM 115.

In 613, the secondary memory controller 112 returns control to the primary memory controller 104. This may be initiated by the CPU, or, in some embodiments, via the energy controller 110, automatically. The primary memory controller 104 may then take the DDR RAM 125 and other memory out of self refresh mode as shown in 615. Finally, as shown in 617, control is handed back to the operating system.

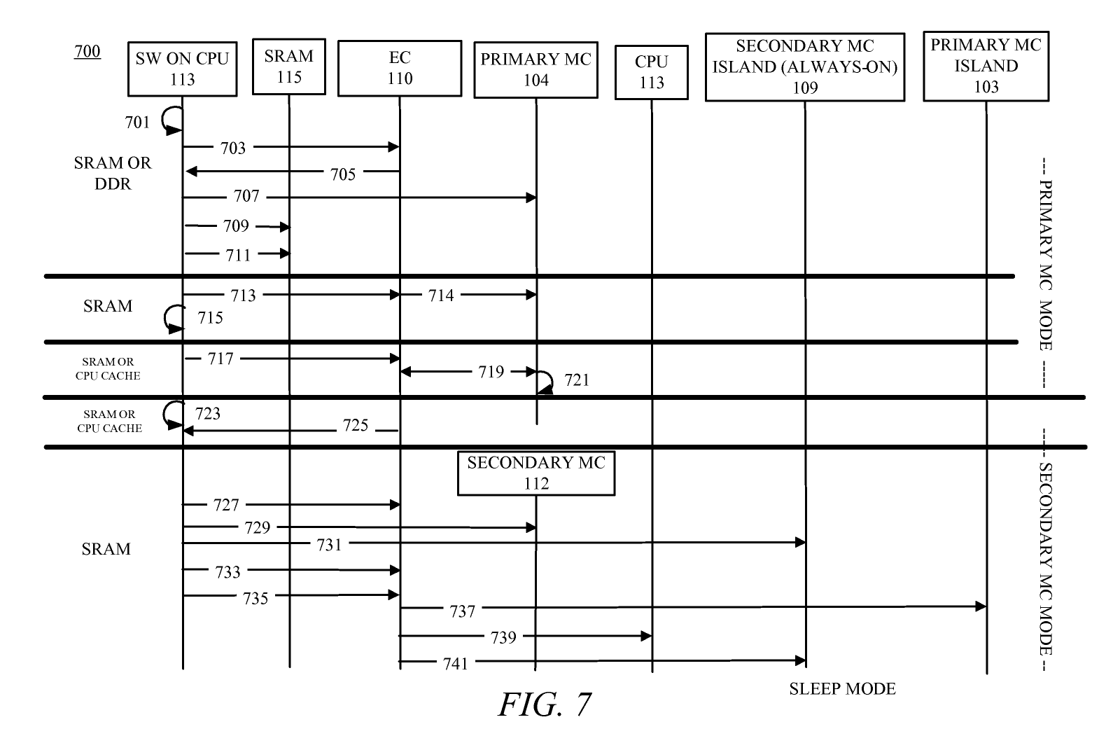

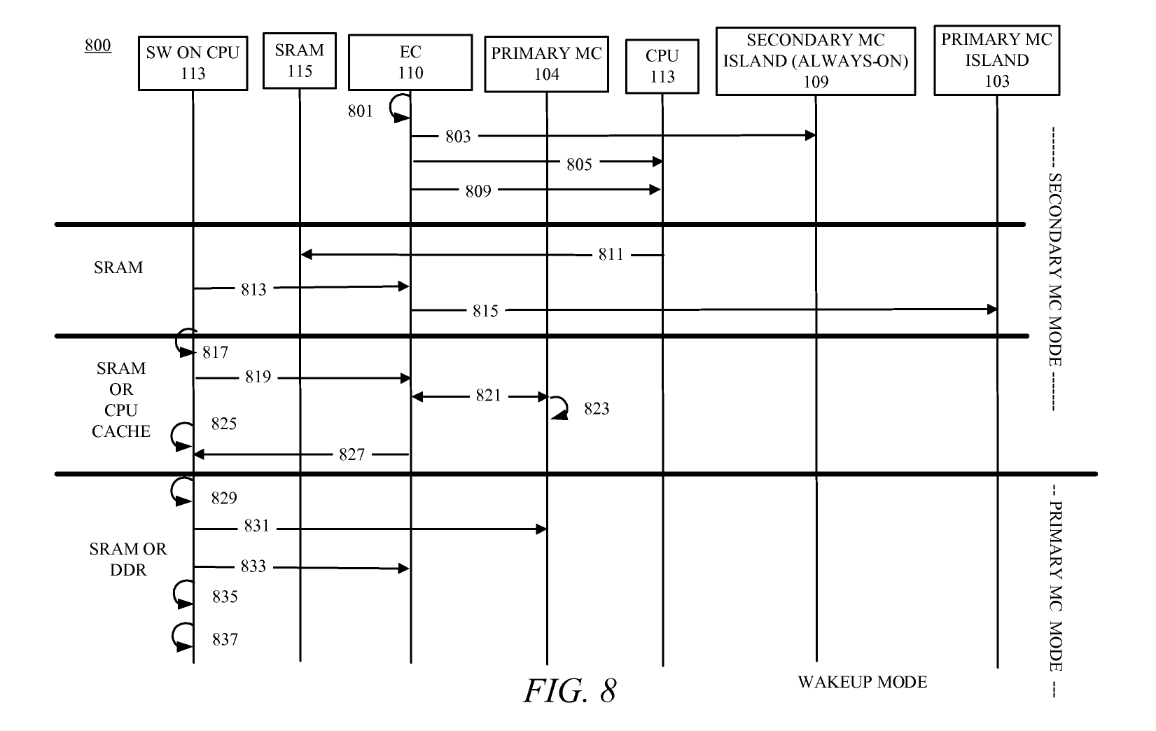

FIG. 7 and FIG. 8 are signal flow diagrams providing additional details of embodiments utilizing the sleep and wakeup procedures as disclosed herein. In FIG. 7 and 8, the blocks at the top of the diagram, represent software and/or components of the integrated circuit 100. For example, the software operating on the CPU 113. The software may be the operating system or may be the sleep mode code 116 or wakeup code 117. This code may be located in various locations as indicated by the left hand column of the diagrams. For example, the code may be located on the random access memory or DDR, the random access memory alone or the CPU cache. The right hand column of the diagrams, indicates which signals of the signal flow occur when the primary memory controller is operational or when the secondary memory controller is operational. FIG. 7 illustrates a sleep mode operation 700 in a accordance with the embodiments.

Initially, the operating system is running on the CPU and is the software on CPU 113. The software or operating system must decide that it is acceptable for the integrated circuit 100 to enter into a sleep mode. Once this happens, a context save may be made, for example, to the DDR RAM 125. This is illustrated in FIG. 7 as signal 701. The context information stored to the DDR RAM 125 is a complete context information. That is, a complete context information for all systems and processes operating on integrated circuit 100 prior to beginning the sleep mode process 700. The signal 701 includes the operating system preparation for entering low power mode. Therefore, the operating system on CPU 113 may send a performance request 703 to the energy controller 110 requesting a low power performance mode. The energy controller 110 may respond to the operating system with an appropriate message or interrupt 705. As was discussed previously, the operating system may in some embodiments, instruct the primary memory controller 104 to reserve memory for the sleep mode code and wakeup code, and may mark it as secure memory to prevent tampering, as illustrated by signal 701. The operating system may then copy the sleep mode 116 and wakeup code 117 to the on-die RAM 115 as shown by signal 709. The operating system may then transfer to, or otherwise jump to, the sleep mode code in the on-die RAM 115 as shown by message 711. As illustrated by the left hand side of FIG. 7, the software on the CPU 113 is now located on the RAM 115.

The sleep mode code 116, now running as the software on the CPU 113, may send a message 713 to the energy controller 110, which in turn sends message 714 to the primary memory controller 104, to instruct the primary memory controller 104 to transfer control to the secondary memory controller. In response to message 714, the primary memory controller may also place a memory, such as DDR RAM 125, into a self-refresh mode. The DDR RAM 125 stores the full context of the integrated circuit 100, and the entire OS image, in the example illustrated by FIG. 7.

In some embodiments, the sleep mode code 116 may cause the CPU, as shown by signal 715, to prepare to run the remainder of the sleep mode code from the CPU cache, due to the forthcoming change of memory to the self-refresh mode. However, using the CPU cache is not necessary in most embodiments, as the sleep mode code may be run entirely from the SRAM 115. At this point, the sleep mode code may send message 717 to the energy controller 110 instructing it to initiate the switch to the secondary memory controller 109. Handshaking 719 may occur between the primary memory controller 104 and the energy controller 110, prior to transitioning to the secondary memory controller 112. The primary memory controller 104 may then place the DDR RAM 125 in a self-refresh mode by a signal 721. The sleep mode code 116 executing on the CPU, may poll the secondary memory controller for activity by a message 723. When the secondary memory controller is active, it may respond via the energy controller 110 and message 725. The sleep mode code 116 running on the CPU 113 may communicate further with the energy controller 110 via various messages, such as, but not limited to, message 727, which may program the energy controller 110 such that various indexes correspond to various power modes of the circuit islands of integrated circuit 100. The sleep mode code 116 may send a message to the memory controller 114, such as message 729, to set it up so that a CPU reset vector points to the wakeup code 117. If possible, the sleep mode code may send message 731 to the secondary memory controller 112, to power down various portions of the random access memory, if possible. The software may then perform clock management via clock management messages 733 to the energy controller 110, and instruct the energy controller 110 to power down the primary memory controller 103 via message 735. In response, the energy controller 110 may send message 737 to the primary memory controller 103, causing it to be power gated. Further, the energy controller 110 may power gate the CPU 113 as shown by signal 739, and may turn off clocking to the secondary memory controller island 109 via signal 741.

FIG. 8 illustrates a wakeup procedure 800 corresponding to the sleep mode procedure 700 illustrated in FIG. 7. Thus, the signal 801 represents an interrupt received by the energy controller 110. The interrupt corresponds to a wakeup event causing the system to wake from the sleep mode. It is to be understood in FIG. 8 that an interrupt controller logic, although not shown, is also present and therefore, the interrupt signal 801 represents an interrupt handled via an interrupt controller logic. In response to the wakeup event, the energy controller 110 may send signal 803 to the secondary memory controller island 109 and turn the clocking back on. At this point, the energy controller 110 may also, in response to the interrupt wakeup event signal 801, send the corresponding interrupt 805 to the CPU 113, which may be done in conjunction with a chip interrupt logic (not shown). The energy controller 110 may then send a reset signal to the CPU 113 as reset 809, and may also turn on clocking signals to the CPU 113. The CPU 113 may then handle the interrupt via the wakeup code 117, which is stored in the on-die RAM 115.

As shown by signal 811, the CPU 113 may transfer to, or “jump to,” the wakeup code 117 stored in the RAM 115. The wakeup code 117 running on the CPU 113 from the SRAM 115, may now send the instruction 813 to the energy controller 110 instructing it to wakeup the primary memory controller 104 via the primary memory controller island 103 and message 815. The wakeup code 117, running on the CPU 113, may retrieve context information via operation 817, the context information being stored on the on-die RAM 115, and place it into the CPU cache. However, for most embodiments the wakeup code 117 will be run entirely from the on-die RAM 115. The CPU may then run the code from the on-die RAM 115, or the cache in some embodiments, while the transfer from the secondary memory controller 112 to the primary memory controller 104 is occurring. The wakeup code 117 may send instruction 819 to the energy controller 110 requesting a transition back to the primary memory controller 104. Handshaking 821 may then occur between the primary memory controller 104 and the energy controller 110. Further, the primary memory controller 104 may take the DDR RAM 125 out of self-refresh mode via instruction 823. The wakeup code 117, running on the CPU 113, may then poll the energy controller 110, as shown by message 825, to check whether the primary memory controller 104 is active. The energy controller 110 may send a response message 827 to the CPU indicating that the primary memory controller 104 has now become active again. The CPU 113 may then jump to the restoration code, that is, the overall context information, stored in the DDR RAM 125 as shown by 829. The CPU may then perform various cleanup operations such as CPU reset vector remapping (to undo the set up from message 729 which set the CPU reset vector to point to the wakeup code 117), as shown by signal 831, and restoring clock frequencies via signal 833. Lastly, the operating system takes over as shown by 835, and the wakeup event is handled by the operating system as shown by signal 837.

In accordance with the various embodiments herein disclosed, the operating system, running for example on the CPU of CPU island 113, performs the sleep mode and wakeup mode operations transparently. That is, the operating system has no awareness of the operations taking place during the sleep mode and wakeup mode operations. The operating system only has awareness that a sleep event and wakeup event have occurred. In accordance with the embodiments, although various circuit islands of the integrated circuit 100 are placed into a sleep mode or suspended, including the primary memory controller circuit island 103, the full operating context of the integrated circuit 100 is restored upon a wakeup event. Various applications of the various embodiments may occur to one in ordinary skill. For example, an audio application via audio processor 107 on the primary memory controller island 103 may be operating. In such a scenario, the CPU island 113 may be shut down with no adverse effects to the audio thereby providing a low power audio playback mode. Various other possibilities will be apparent to those of ordinary skill.

In the exemplary embodiments herein described, the sleep mode code 116 and wakeup code 117 were exemplified as software codes stored in on-die RAM 115. However, other embodiments may include logic operative to perform the sleep mode and wakeup mode operations herein disclosed and remain in accordance with the embodiments. Further other embodiments may include a combination of software code such as sleep mode code 116 and wakeup code 117, stored in the on-die RAM 115, in combination with various logic located on the integrated circuit 100. For example, such logic may be included on the secondary memory controller island 109 along with the secondary memory controller 112. For the exemplary embodiments disclosed herein, and with respect to the integrated circuit 100 example illustrated in FIG. 1, the CPU of CPU island 113 in combination with the sleep mode code 116 and/or the wakeup code 117, formulate logic operative to transfer control of memory access, from the primary memory controller 104 to the secondary memory controller 112, for entering the sleep mode of the integrated circuit 100. The sleep mode of the embodiments may include placing one or several circuit islands of integrated circuit 100 into sleep mode, and, for example, may include placing the primary memory controller island 103 into a sleep mode.

As used herein, the term CPU or “processor” may refer to one or more dedicated or non-dedicated: microprocessors, microcontrollers, sequencers, microsequencers, digital signal processors, processing engines, hardware accelerators (e.g., GPUs), application specific circuits (ASICs), state machines, programmable logic arrays, and/or any single or collection of circuit components that is or are capable of processing data or information, and any combination of the above. Similarly, “memory” may refer to any suitable volatile or non-volatile memory, memory device, chip or circuit, or any storage device, chip or circuit such as, but not limited to, system memory, frame buffer memory, flash memory, random access memory (RAM), read only memory (ROM), a register, a latch, or any combination of the above. For the avoidance of doubt “logic” may refer to any electric circuitry or circuit components (whether on one or more circuits or integrated circuits) such as but not limited to processors (capable of executing executable instructions), transistors, electronic circuitry, memory, combination logic circuit, or any combination of the above that is capable of providing a desired operation(s) or function(s). The term “integrated circuit” may be used interchangeably to designate both a circuit in its totality (e.g., a chip) and a partial section of the same. A “signal” may refer to any suitable data, information or indicator. Additionally, as will be appreciated by those of ordinary skill in the art, the operation, design, and organization, of a “module” or processor can be described in a hardware description language such as Verilog™, VHDL, or other suitable hardware description languages, such hardware description language code or instructions being capable of being stored on a computer readable medium.

The above detailed description and the examples described therein have been presented for the purposes of illustration and description only and not for limitation. For example, the operations described may be done in any suitable manner. The method steps may be done in any suitable order still providing the described operation end results. It is therefore contemplated that the present embodiments cover any and all modifications, variations or equivalents that fall within the spirit and scope of the basic underlying principles disclosed above and claimed herein.

What is claimed is:

1. A method comprising:
storing minimum operation context information to a random access memory (RAM) in response to a sleep mode being allowable;
switching to a sleep mode code in said RAM; and
transferring memory control from a primary memory controller to a secondary memory controller wherein said secondary memory controller only controls said RAM.

2. The method of claim 1, comprising:
storing said sleep mode code and a wakeup code to said RAM in response to determining that a minimum operation level has been reached, and that said sleep mode is therefore allowable, said wakeup code for restoring a minimum operation context using said minimum operation context information stored in said RAM.

3. The method of claim 1, comprising:
placing a plurality of integrated circuit power islands into a powered off mode and leaving a secondary memory controller power island in a normal power mode.

4. The method of claim 1, prior to placing a plurality of integrated circuit power islands into a powered off mode and leaving a secondary memory controller power island in a normal power mode, comprising:
storing an overall operation context information to a dynamic memory; and
placing said dynamic memory into a self-refresh mode.

5. The method of claim 1, comprising:
storing a full context information in a memory in response to determining that a minimum operation level has been reached and that said sleep mode is therefore allowable.

6. The method of claim 3, comprising:
placing a central processing unit (CPU) power island, and a primary memory controller power island into said powered off mode.

7. The method of claim 1, prior to switching to a sleep mode code in said RAM, comprising:
sending a command to said primary memory controller to mark a region of RAM as secure memory, said region of RAM for storing said minimum operation context information and a wakeup code.

8. A method comprising:
receiving a hardware interrupt in an integrated circuit, said integrated circuit being in a sleep mode;
receiving a request to wakeup said integrated circuit in response to receiving said hardware interrupt;
accessing, by said secondary memory controller, a wakeup code, said wakeup code stored in a RAM and for restoring a minimum operation context of said integrated circuit;
executing said wakeup code and restoring a minimum operation context of said integrated circuit; and
transferring memory control from said secondary memory controller to a primary memory controller.

9. The method of claim 8, prior to transferring memory control from said secondary memory controller to a primary memory controller, comprising:
restoring power to a primary memory controller power island of said integrated circuit; and
restoring a full operation context of said integrated circuit using a full operation context information stored in said RAM.

10. The method of claim 9, comprising:
transferring control of said integrated circuit from said wakeup code to an integrated circuit operating system, said integrated circuit operating system returning to said full operation context.

11. The method of claim 9, comprising:
taking a dynamic memory out of a self-refresh mode wherein said dynamic memory stores an overall operation context information.

12. The method of claim 9, comprising:
restoring power to a digital still camera power island, a video power island and a peripheral power island.

13. The method of claim 8 wherein an energy controller, located on a secondary memory controller power island along with said secondary memory controller, receives a request for normal operating power based on said hardware interrupt.

14. An integrated circuit comprising:
a random access memory (RAM);
a primary memory controller operatively coupled to said RAM and to other memory of said integrated circuit, said primary memory controller located on a memory controller island of said plurality of circuit islands;
a secondary memory controller operatively coupled to said RAM and located on a secondary memory controller island, said secondary memory controller dedicated to control of said RAM upon transfer of control from said primary memory controller, said secondary memory controller operative to provide access to a minimum operation context information from said RAM during a wakeup operation; and
logic operative to transfer control from said primary memory controller to said secondary memory controller for entering a sleep mode of said integrated circuit, said sleep mode including placing said memory controller island into a sleep mode.

15. The integrated circuit of claim 14, comprising:
a processor operatively coupled to said RAM, said primary memory controller and said secondary memory controller, and operative to:
determine that a minimum operation level of an integrated circuit has been reached and that a sleep mode is therefore allowable;
store minimum operation context information to said RAM in response to determining that said minimum operation level has been reached;
switch to a sleep mode code in said RAM; and
hand memory control from said primary memory controller to said secondary memory controller.

16. The integrated circuit of claim 15, wherein said processor is further operative to:
store said sleep mode code and a wakeup code in said RAM in response to determining that said minimum operation level has been reached, said wakeup code for restoring a minimum operation context using said minimum operation context information stored in said RAM.

17. The integrated circuit of claim 14, further comprising:
an energy controller located on a secondary memory controller power island along with said secondary memory controller, said energy controller being operatively coupled to said secondary memory controller and said processor, said energy controller being operative to:
place a plurality of integrated circuit power islands into a sleep mode and leaving said secondary memory controller power island in a normal power mode.

18. The integrated circuit of claim 15, wherein said processor is further operative to:
store a full context information in a memory in response to determining that said minimum operation level has been reached.

19. The integrated circuit of claim 18, wherein said primary memory controller is operative to:
place said memory into a self-refresh mode.

20. The integrated circuit of claim 16, wherein said processor is further operative to:
receive a hardware interrupt while being in a sleep mode, said hardware interrupt corresponding to a wakeup event; and
wherein said secondary memory controller is operative to:
access said wakeup code, said wakeup code stored in a RAM and for restoring a minimum operation context of said integrated circuit;
wherein said processor is further operative to:
run said wakeup code and restore a minimum operation context of said integrated circuit; and
hand memory control from said secondary memory controller to said primary memory controller.

21. A computer readable medium storing instructions for a design of a processor, the processor, when manufactured, is adapted to:
store minimum operation context information to a random access memory (RAM) in response to a sleep mode being allowable;
switch to a sleep mode code in said RAM; and
transfer memory control from a primary memory controller to a secondary memory controller wherein said secondary memory controller only controls said RAM.

22. The computer readable medium of claim 21 wherein said instructions comprise hardware description language instructions.
